(19) United States
(12) Patent Application Publication
(10) Pub. No.: US 2012/0194397 A1
(43) Pub. Date: Aug. 2, 2012

(54) SYSTEM AND METHODS FOR SETTING UP SATELLITE DISHES LOCATED ON ROOF TOPS

(75) Inventor: TAI CHEUNG POON, HONG KONG (HK)

(73) Assignee: DISH ANGLE LIMITED, HONG KONG (HK)

(21) Appl. No.: 13/015,935

(22) Filed: Jan. 28, 2011

(51) Int. Cl. H01Q 3/00

(52) U.S. Cl. 343/760

(57) ABSTRACT

A system is provided for setting up satellite dishes located on roof tops to receive most favorable signals in view of locations of the emission towers and the roof tops, without requiring manual adjustment of the satellite dishes. In one embodiment, an inventive system includes an emission tower emitting satellite signals; a location detection control centre located within the emission tower, wherein the centre receives signals reported by location detection devices included in cell phones; a satellite dish included in a satellite receiving device being placed on a roof top of a house, wherein the roof top is tilted at a slanted angle in relation to earth horizon; a housing used included in the satellite receiving device to house the satellite dish; a turning arm connecting between the housing and the satellite dish, allowing the satellite dish to turn freely at a receptive angle in order to receive favorable reception signals; a cell phone including an accelerometer is used for orientation and positioning of the phone; a compass device included in the cell phone; a location detection device included in the cell phone; a control processing unit and a memory unit included in the cell phone.

### FIELD OF THE INVENTION

This invention is generally related to setting up satellite dishes located on roof tops. Specifically, but not limited to, this invention relates to receiving a current location by using the location detection device included in the cell phone; sending the current location to the location detection control centre located within the emission tower; receiving a suggested best direction from the location detection control centre; and commanding the satellite receiving device to receive the most favorable reception signals, with respect to the emission tower.

### BACKGROUND OF THE INVENTION

Presently, compact satellite dishes perched on rooftops are very popular all over the world. When a person drives through rural areas beyond the reach of the cable companies, the person will find dishes on just about every house. The major satellite TV companies are luring in more consumers every day with movies, sporting events and news from around the world and the promise of movie-quality picture and sound.

While satellite TV is becoming increasingly popular, problems arise regarding the setup of satellite dishes. During startup, manual adjustment is required when a satellite dish is purchased. Such an adjustment is required in order to receive signals adequately. If the adjustment is made inappropriately, poor receptions may result. Currently, there is no automated means for performing such adjustments. Also, there are no technologies that can adjust the location by which the satellite dish is located. Therefore, it is highly valuable to automate the process of installing satellite dishes in order to receive most favorable signals.

### SUMMARY OF THE INVENTION

Embodiments of the present invention include a system for setting up satellite dishes located on roof tops to receive most favorable signals in view of locations of the emission towers and the roof tops, without requiring manual adjustment of the satellite dishes. In one embodiment, the system includes an emission tower emitting satellite signals; a location detection control centre located within the emission tower, wherein the centre receives signals reported by location detection devices included in cell phones; a satellite dish included in a satellite receiving device being placed on a roof top of a house, wherein the roof top is tilted at a slanted angle in relation to earth horizon; a housing used included in the satellite receiving device to house the satellite dish; a turning arm connecting between the housing and the satellite dish, allowing the satellite dish to turn freely at a receptive angle in order to receive favorable reception signals; a cell phone including an accelerometer is used for orientation and positioning of the phone, wherein if the cell phone is tilted by its side, a motion sensor within the accelerometer is adapted to measure an angle by which the cell phone is tilted with respect to gravity; a compass device included in the cell phone; a location detection device included in the cell phone; a control processing unit and a memory unit included in the cell phone, wherein the cell phone execute instructions by causing the processing unit to execute a method.

In accordance with one aspect of the embodiment, the method comprises receiving a current location by using the location detection device included in the cell phone; sending the current location to the location detection control centre located within the emission tower; receiving a suggested best direction from the location detection control centre; and commanding, by the cell phone, the satellite receiving device to receive the most favorable reception signals, with respect to the emission tower.

According to an additional embodiment, after receiving the suggested best direction from the location detection control centre, the cell phone may command the satellite receiving device to receive the most favorable reception signals, wherein the commanding is made based on the best suggested direction received from the location detection control centre and information computed by the cell phone.

Alternatively, after receiving the suggested best direction from the location detection control centre, the cell phone may command the satellite receiving device to receive the most favorable reception signals, wherein the commanding is made based on the best suggested direction received from the location detection control centre and information computed by the cell phone, and the commanding requires the turning arm connecting between the housing and the location detection control centre located within the emission tower to turn at a most favorable receptive angle in order to receive the most favorable reception signals.

In yet another alternative, the commanding can be made based on the best suggested direction received from the location detection control centre and information computed by the cell phone, the information computed by the cell phone including the slanted angle where the roof top is tilted in relation to earth horizon; the direction where the roof top is tilted in relation to earth horizon; and the attitude of the roof top.

In another alternative, the commanding may require the turning arm connecting between the housing and the location detection control centre located within the emission tower to turn at the most favorable receptive angle in order to receive the most favorable reception signals.

In a different embodiment of the present invention, the location detection control centre located within the emission tower can receive the current location sent by the cell phone. The location detection control centre may be based on the received current location reported by the location detection device included in the cell phone. A suggested best direction may be computed to determine a best direction of which satellite signals are best received in view of the emission tower and the current location reported by the location detection device included in the cell phone; and sends information back to the cell phone, wherein the information includes the best suggested direction that determines the best direction of which satellite signals are best received in view of the current location reported by the location detection device included in the cell phone.

Further, the cell phone may further compute information serving as compensating factors in view of the slanted roof top. As an example, such information may include the slanted angle where the roof top is tilted in relation to earth horizon, wherein the slanted angle is measured by placing the mobile phone on the roof top that is tilted at the slanted angle in relation to the earth horizon; and using the accelerometer device to report a reading providing a current angle of orientation of the mobile phone with respect to the gravity, wherein the current angle of orientation is used to represent the slanted angle of the roof top; the direction where the roof top is tilted in relation to earth horizon, wherein the direction is measured by using the compassing device to report a reading providing current direction of the mobile phone, wherein the current direction of the mobile phone is used to represent the direction where the roof top is slanted at; and the attitude of the roof top, wherein the attitude of the roof top is measured by a location detecting device or a global positioning system receiver included in the cell phone.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a system for setting up satellite dishes, consistent with an embodiment of the invention.

### DETAILED DESCRIPTION

Embodiments of the present invention relates to a system for setting up satellite dishes located on roof tops to receive most favorable signals in view of locations of the emission towers and the roof tops, without requiring manual adjustment of the satellite dishes.

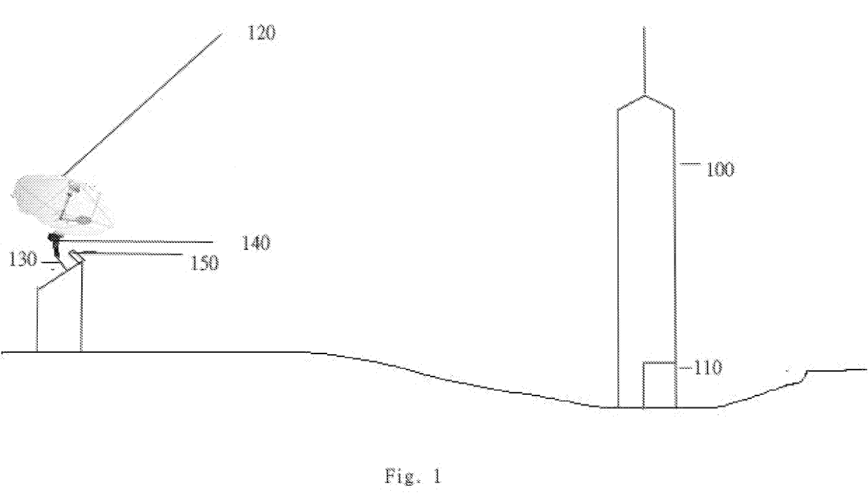

FIG. 1 refers to a system for setting up satellite dishes (120). The system includes an emission tower (100) emitting satellite signals; a location detection control centre (110) located within the emission tower (100), wherein the centre receives signals reported by location detection devices included in cell phones; a satellite dish (120) included in a satellite receiving device being placed on a roof top of a house, wherein the roof top is tilted at a slanted angle in relation to earth horizon; a housing (130) used included in the satellite receiving device to house the satellite dish (120); a turning arm connecting between the housing (130) and the satellite dish (120), allowing the satellite dish (120) to turn freely at a receptive angle in order to receive favorable reception signals; a cell phone (150) including an accelerometer is used for orientation and positioning of the phone, wherein if the cell phone (150) is tilted by its side, a motion sensor within the accelerometer is adapted to measure an angle by which the cell phone (150) is tilted with respect to gravity; a compass device included in the cell phone; a location detection device included in the cell phone; a control processing unit and a memory unit included in the cell phone, wherein the cell phone (150) execute instructions by causing the processing unit to execute a method. The method comprises receiving a current location by using the location detection device included in the cell phone; sending the current location to the location detection control centre (110) located within the emission tower (100); receiving a suggested best direction from the location detection control centre (110); and commanding, by the cell phone, the satellite receiving device to receive the most favorable reception signals, with respect to the emission tower.

In a different aspect of the invention, the inventive system comprises an emission tower (100) emitting satellite signals; a location detection control centre (110) located within the emission tower (100), wherein the centre receives signals reported by location detection devices included in cell phones; a satellite dish (120) included in a satellite receiving device being placed on a roof top of a house, wherein the roof top is tilted at a slanted angle in relation to earth horizon; a housing (130) used included in the satellite receiving device to house the satellite dish (120); a turning arm connecting between the housing (130) and the satellite dish (120), allowing the satellite dish (120) to turn freely at a receptive angle in order to receive favorable reception signals; a cell phone (150) including an accelerometer is used for orientation and positioning of the phone, wherein if the cell phone (150) is tilted by its side, a motion sensor within the accelerometer is adapted to measure an angle by which the cell phone (150) is tilted with respect to gravity; a compass device included in the cell phone; a location detection device included in the cell phone; a control processing unit and a memory unit included in the cell phone, wherein the cell phone (150) execute instructions by causing the processing unit to execute a method. The method comprises receiving a current location by using the location detection device included in the cell phone; sending the current location to the location detection control centre (110) located within the emission tower (100); receiving a suggested best direction from the location detection control centre (110); and commanding, by the cell phone, the satellite receiving device to receive the most favorable reception signals, wherein: the commanding is made based on the best suggested direction received from the location detection control centre (110) and information computed by the cell phone, and the commanding requires the turning arm connecting between the housing (130) and the location detection control centre (110) located within the emission tower (100) to turn at a most favorable receptive angle in order to receive the most favorable reception signals.

In another implementation, the inventive system comprises an emission tower (100) emitting satellite signals; a location detection control centre (110) located within the emission tower (100), wherein the centre receives signals reported by location detection devices included in cell phones; a satellite dish (120) included in a satellite receiving device being placed on a roof top of a house, wherein the roof top is tilted at a slanted angle in relation to earth horizon; a housing (130) used included in the satellite receiving device to house the satellite dish (120); a turning arm connecting between the housing (130) and the satellite dish (120), allowing the satellite dish (120) to turn freely at a receptive angle in order to receive favorable reception signals; a cell phone (150) including an accelerometer is used for orientation and positioning of the phone, wherein if the cell phone (150) is tilted by its side, a motion sensor within the accelerometer is adapted to measure an angle by which the cell phone (150) is tilted with respect to gravity; a compass device included in the cell phone; a location detection device included in the cell phone; a control processing unit and a memory unit included in the cell phone, wherein the cell phone (150) execute instructions by causing the processing unit to execute a method, the method comprising receiving a current location by using the location detection device included in the cell phone; sending the current location to the location detection control centre (110) located within the emission tower (100); receiving a suggested best direction from the location detection control centre (110); and commanding, by the cell phone, the satellite receiving device to receive the most favorable reception signals.

The commanding can be made based on the best suggested direction received from the location detection control centre (110) and information computed by the cell phone, the information computed by the cell phone (150) including the slanted angle where the roof top is tilted in relation to earth horizon; the direction where the roof top is tilted in relation to earth horizon; and the attitude of the roof top; and the commanding requires the turning arm connecting between the housing (130) and the location detection control centre (110) located within the emission tower (100) to turn at the most favorable receptive angle in order to receive the most favorable reception signals.

In another exemplary implementation, the present system includes a system for setting up satellite dishes (120) located on roof tops to receive most favorable signals in view of locations of the emission towers (100) and the roof tops, without requiring manual adjustment of the satellite dishes. The system comprises an emission tower (100) emitting satellite signals; a location detection control centre (110) located within the emission tower (100), wherein the centre receives signals reported by location detection devices included in cell phones; a satellite dish (120) included in a satellite receiving device being placed on a roof top of a house, wherein the roof top is tilted at a slanted angle in relation to earth horizon; a housing (130) used included in the satellite receiving device to house the satellite dish; a turning arm connecting between the housing (130) and the satellite dish, allowing the satellite dish (120) to turn freely at a receptive angle in order to receive favorable reception signals; a cell phone (150) including an accelerometer is used for orientation and positioning of the phone, wherein if the cell phone (150) is tilted by its side, a motion sensor within the accelerometer is adapted to measure an angle by which the cell phone (150) is tilted with respect to gravity; a compass device included in the cell phone; a location detection device included in the cell phone; a control processing unit and a memory unit included in the cell phone.

The cell phone (150) may execute instructions by causing the processing unit to execute a method, the method comprising: receiving a current location by using the location detection device included in the cell phone; sending the current location to the location detection control centre (110) located within the emission tower (100), wherein the location detection control centre (110): based on the received current location reported by the location detection device included in the cell phone, computes a suggested best direction, wherein the suggested best direction determines a best direction of which satellite signals are best received in view of the emission tower (100) and the current location reported by the location detection device included in the cell phone; sends information back to the cell phone, wherein the information includes the best suggested direction that determines the best direction of which satellite signals are best received in view of the current location reported by the location detection device included in the cell phone; receiving a suggested best direction from the location detection control centre (110); and commanding, by the cell phone, the satellite receiving device to receive the most favorable reception signals, wherein the commanding is made based on the best suggested direction received from the location detection control centre (110) and information computed by the cell phone, the information computed by the cell phone (150) including the slanted angle where the roof top is tilted in relation to earth horizon; the direction where the roof top is tilted in relation to earth horizon; and the attitude of the roof top; and the commanding requires the turning arm connecting between the housing (130) and the location detection control centre (110) located within the emission tower (100) to turn at the most favorable receptive angle in order to receive the most favorable reception signals.

In yet a alternative implementation, a system is provided for setting up satellite dishes located on roof tops to receive most favorable signals in view of locations of the emission towers (100) and the roof tops, without requiring manual adjustment of the satellite dishes. The system comprises an emission tower (100) emitting satellite signals; a location detection control centre (110) located within the emission tower (100), wherein the centre receives signals reported by location detection devices included in cell phones; a satellite dish (120) included in a satellite receiving device being placed on a roof top of a house, wherein the roof top is tilted at a slanted angle in relation to earth horizon; a housing (130) used included in the satellite receiving device to house the satellite dish; a turning arm (140)connecting between the housing (130) and the satellite dish, allowing the satellite dish (120) to turn freely at a receptive angle in order to receive favorable reception signals; a cell phone (150) including an accelerometer is used for orientation and positioning of the phone, wherein if the cell phone (150) is tilted by its side, a motion sensor within the accelerometer is adapted to measure an angle by which the cell phone (150) is tilted with respect to gravity; a compass device included in the cell phone; a location detection device included in the cell phone; a control processing unit and a memory unit included in the cell phone, wherein the cell phone (150) execute instructions by causing the processing unit to execute a method, the method comprising receiving a current location by using the location detection device included in the cell phone; sending the current location to the location detection control centre (110) located within the emission tower (100), wherein the location detection control centre (110), based on the received current location reported by the location detection device included in the cell phone, computes a suggested best direction, wherein the suggested best direction determines a best direction of which satellite signals are best received in view of the emission tower (100) and the current location reported by the location detection device included in the cell phone; sends information back to the cell phone, wherein the information includes the best suggested direction that determines the best direction of which satellite signals are best received in view of the current location reported by the location detection device included in the cell phone; receiving a suggested best direction from the location detection control centre (110); and commanding, by the cell phone, the satellite receiving device to receive the most favorable reception signals.

The commanding may at this point require the turning arm (140)connecting between the housing (130) and the location detection control centre (110) located within the emission tower (100) to turn at the most favorable receptive angle in order to receive the most favorable reception signals; and the commanding is made based on the best suggested direction received from the location detection control centre (110) and information computed by the cell phone, the information computed by the cell phone (150) serving as compensating factors in view of the slanted roof top, including the slanted angle where the roof top is tilted in relation to earth horizon, wherein the slanted angle is measured by placing the mobile phone on the roof top that is tilted at the slanted angle in relation to the earth horizon; and using the accelerometer device to report a reading providing a current angle of orientation of the mobile phone with respect to the gravity, wherein the current angle of orientation is used to represent the slanted angle of the roof top; the direction where the roof top is tilted in relation to earth horizon, wherein the direction is measured by using the compassing device to report a reading providing current direction of the mobile phone, wherein the current direction of the mobile phone is used to represent the direction where the roof top is slanted at; and the attitude of the roof top, wherein the attitude of the roof top is measured by a location detecting device or a global positioning system receiver included in the cell phone.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A system for setting up satellite dishes located on roof tops to receive most favorable signals in view of locations of the emission towers and the roof tops, without requiring manual adjustment of the satellite dishes, comprising:
an emission tower emitting satellite signals;
a location detection control centre located within the emission tower, wherein the centre receives signals reported by location detection devices included in cell phones;
a satellite dish included in a satellite receiving device being placed on a roof top of a house, wherein the roof top is tilted at a slanted angle in relation to earth horizon;
a housing used included in the satellite receiving device to house the satellite dish;
a turning arm connecting between the housing and the satellite dish, allowing the satellite dish to turn freely at a receptive angle in order to receive favorable reception signals;
a cell phone including an accelerometer is used for orientation and positioning of the phone, wherein if the cell phone is tilted by its side,
a motion sensor within the accelerometer is adapted to measure an angle by which the cell phone is tilted with respect to gravity;
a compass device included in the cell phone;
a location detection device included in the cell phone;
a control processing unit and a memory unit included in the cell phone, wherein the cell phone execute instructions by causing the processing unit to execute a method, the method comprising:
receiving a current location by using the location detection device included in the cell phone;
sending the current location to the location detection control centre located within the emission tower;
receiving a suggested best direction from the location detection control centre; and
commanding, by the cell phone, the satellite receiving device to receive the most favorable reception signals, with respect to the emission tower.

2. The system of claim 1, wherein the method comprises:
receiving a current location by using the location detection device included in the cell phone;
sending the current location to the location detection control centre located within the emission tower;
receiving a suggested best direction from the location detection control centre; and
commanding, by the cell phone, the satellite receiving device to receive the most favorable reception signals, wherein the commanding is made based on the best suggested direction received from the location detection control centre and information computed by the cell phone.

3. The system of claim 1, wherein the method comprises:
receiving a current location by using the location detection device included in the cell phone;
sending the current location to the location detection control centre located within the emission tower;
receiving a suggested best direction from the location detection control centre; and
commanding, by the cell phone, the satellite receiving device to receive the most favorable reception signals, wherein:
the commanding is made based on the best suggested direction received from the location detection control centre and information computed by the cell phone, and
the commanding requires the turning arm connecting between the housing and the location detection control centre located within the emission tower to turn at a most favorable receptive angle in order to receive the most favorable reception signals.

4. The system of claim 1, wherein the method comprises:
receiving a current location by using the location detection device included in the cell phone;
sending the current location to the location detection control centre located within the emission tower;
receiving a suggested best direction from the location detection control centre; and
commanding, by the cell phone, the satellite receiving device to receive the most favorable reception signals, wherein:
the commanding is made based on the best suggested direction received from the location detection control centre and information computed by the cell phone, the information computed by the cell phone including:
the slanted angle where the roof top is tilted in relation to earth horizon;
the direction where the roof top is tilted in relation to earth horizon; and
the attitude of the roof top; and
the commanding requires the turning arm connecting between the housing and the location detection control centre located within the emission tower to turn at the most favorable receptive angle in order to receive the most favorable reception signals.

5. The system of claim 1, wherein the method comprises:
receiving a current location by using the location detection device included in the cell phone;
sending the current location to the location detection control centre located within the emission tower, wherein the location detection control centre:
based on the received current location reported by the location detection device included in the cell phone, computes a suggested best direction, wherein the suggested best direction determines a best direction of which satellite signals are best received in view of the emission tower and the current location reported by the location detection device included in the cell phone;
sends information back to the cell phone, wherein the information includes the best suggested direction that determines the best direction of which satellite signals are best received in view of the current location reported by the location detection device included in the cell phone;
receiving a suggested best direction from the location detection control centre; and
commanding, by the cell phone, the satellite receiving device to receive the most favorable reception signals, wherein:
the commanding is made based on the best suggested direction received from the location detection control centre and information computed by the cell phone, the information computed by the cell phone including:
the slanted angle where the roof top is tilted in relation to earth horizon;
the direction where the roof top is tilted in relation to earth horizon; and
the attitude of the roof top; and
the commanding requires the turning arm connecting between the housing and the location detection control centre located within the emission tower to turn at the most favorable receptive angle in order to receive the most favorable reception signals.

6. The system of claim 1, wherein the method comprises:
receiving a current location by using the location detection device included in the cell phone;
sending the current location to the location detection control centre located within the emission tower, wherein the location detection control centre:
based on the received current location reported by the location detection device included in the cell phone, computes a suggested best direction, wherein the suggested best direction determines a best direction of which satellite signals are best received in view of the emission tower and the current location reported by the location detection device included in the cell phone;
sends information back to the cell phone, wherein the information includes the best suggested direction that determines the best direction of which satellite signals are best received in view of the current location reported by the location detection device included in the cell phone;
receiving a suggested best direction from the location detection control centre; and
commanding, by the cell phone, the satellite receiving device to receive the most favorable reception signals, wherein:
the commanding requires the turning arm connecting between the housing and the location detection control centre located within the emission tower to turn at the most favorable receptive angle in order to receive the most favorable reception signals; and
the commanding is made based on the best suggested direction received from the location detection control centre and information computed by the cell phone, the information computed by the cell phone serving as compensating factors in view of the slanted roof top, including:
the slanted angle where the roof top is tilted in relation to earth horizon, wherein the slanted angle is measured by:
placing the mobile phone on the roof top that is tilted at the slanted angle in relation to the earth horizon; and
using the accelerometer device to report a reading providing a current angle of orientation of the mobile phone with respect to the gravity, wherein the current angle of orientation is used to represent the slanted angle of the roof top;
the direction where the roof top is tilted in relation to earth horizon, wherein the direction is measured by using the compassing device to report a reading providing current direction of the mobile phone, wherein the current direction of the mobile phone is used to represent the direction where the roof top is slanted at; and
the attitude of the roof top, wherein the attitude of the roof top is measured by a location detecting device or a global positioning system receiver included in the cell phone.
